(19) United States
(12) Patent Application Publication
(10) Pub. No.: US 2017/0346102 A1
(43) Pub. Date: Nov. 30, 2017

(54) FUEL CELL SYSTEM INCLUDING DENSE OXYGEN BARRIER LAYER

(71) Applicant: LG Fuel Cell Systems, Inc., North Canton, OH (US)

(72) Inventors: Ilias Nikolaidis, Hanau (DE); Zhien Liu, Canal Fulton, OH (US); Minjae Jung, Stow, OH (US); Hwa-Young Jung, Canton, OH (US)

(21) Appl. No.: 15/183,568

(22) Filed: Jun. 15, 2016

Related U.S. Application Data
(60) Provisional application No. 62/175,908, filed on Jun. 15, 2015.

(51) Int. Cl. H01M 8/0228; H01M 8/2404; H01M 8/0206; H01M 8/12; H01M 8/2425; H01M 8/124

(52) U.S. Cl. CPC H01M 8/0228; H01M 8/12; H01M 8/2425; H01M 8/2404; H01M 8/0206; H01M 2008/1293

(57) ABSTRACT

In some examples, a fuel cell including a first electrochemical cell; a second electrochemical cell; an interconnect configured to conduct a flow of electrons from the first electrochemical cell to the second electrochemical cell; and a dense oxygen barrier layer separating the interconnect from one of a cathode or a cathode conductor layer adjacent the cathode, wherein the dense barrier layer is formed of a ceramic material exhibiting a low porosity and a high conductivity such that the dense oxygen barrier layer reduces at least one precious metal loss from the interconnect or oxidation of nickel metal in the interconnect.

This application claims the benefit of U.S. Provisional Application No. 62/175,908, filed Jun. 15, 2015, which is incorporated herein by reference in its entirety.

This invention was made with government support under Cooperative Agreement No. DE-FE0000303 awarded by the Department of Energy. The Government has certain rights in this invention.

### TECHNICAL FIELD

The disclosure generally relates to fuel cells, such as solid oxide fuel cells.

### BACKGROUND

Fuel cells, fuel cell systems and interconnects for fuel cells and fuel cell systems remain an area of interest. Some existing systems have various shortcomings, drawbacks, and disadvantages relative to certain applications. Accordingly, there remains a need for further contributions in this area of technology.

### SUMMARY

Example compositions and configuration for active layers of fuels cells, such as, e.g., solid oxide fuels cells (SOFCs), are described. In one example, the disclosure is directed to a fuel cell comprising a first electrochemical cell; a second electrochemical cell; an interconnect configured to conduct a flow of electrons from the first electrochemical cell to the second electrochemical cell; and a dense oxygen barrier layer separating the interconnect from one of a cathode or a cathode conductor layer adjacent the cathode, wherein the dense barrier layer is formed of a ceramic material exhibiting a low porosity and a high conductivity such that the dense oxygen barrier layer reduces at least one precious metal loss from the interconnect or oxidation of nickel metal in the interconnect.

In another example, the disclosure relates to a method for manufacturing a fuel cell, the method comprising forming a fuel cell structure, the structure comprising a first electrochemical cell; a second electrochemical cell; an interconnect configured to conduct a flow of electrons from the first electrochemical cell to the second electrochemical cell; and a dense oxygen barrier layer separating the interconnect from one of a cathode or a cathode conductor layer adjacent the cathode, wherein the dense barrier layer is formed of a ceramic material exhibiting a low porosity and a high conductivity such that the dense oxygen barrier layer reduces at least one precious metal loss from the interconnect or oxidation of nickel metal in the interconnect.

In another example, the disclosure relates to a method comprising controlling operation of a fuel cell to generate electricity, wherein the fuel cell comprises a first electrochemical cell; a second electrochemical cell; an interconnect configured to conduct a flow of electrons from the first electrochemical cell to the second electrochemical cell; and a dense oxygen barrier layer separating the interconnect from one of a cathode or a cathode conductor layer adjacent the cathode, wherein the dense barrier layer is formed of a ceramic material exhibiting a low porosity and a high conductivity such that the dense oxygen barrier layer reduces at least one precious metal loss from the interconnect or oxidation of nickel metal in the interconnect.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

The description herein makes reference to the accompanying drawings wherein like reference numerals refer to like parts throughout the several views.

FIGS. 1A and 1B are schematic diagrams illustrating example fuel cell structures configured for lateral current path and perpendicular current path, respectively.

FIG. 2 is a schematic diagram illustrating an example fuel cell system in accordance with an embodiment of the present disclosure.

FIGS. 3-7 are a schematic diagram illustrating various example cross-sections of a fuel cell system in accordance with an embodiment of the present disclosure.

FIGS. 8-10 are plots illustrating one or more aspects of the disclosure.

FIGS. 11A and 12A are plots illustrating one or more aspects of the disclosure.

FIGS. 11B and 12B are SEM images illustrating one or more aspects of the disclosure

Referring to the drawings, some aspects of a non-limiting example of a fuel cell system in accordance with an embodiment of the present disclosure is schematically depicted. In the drawing, various features, components and interrelationships therebetween of aspects of an embodiment of the present disclosure are depicted. However, the present disclosure is not limited to the particular embodiments presented and the components, features and interrelationships therebetween as are illustrated in the drawings and described herein.

### DETAILED DESCRIPTION

A solid oxide fuel cell may include an anode, electrolyte, and cathode. When configured in a stack with multiple fuel cells, the anode of one cell is connected with cathode of adjacent cell by an interconnect. The interconnect functions to connect one cell to an adjacent cell electronically to transport electrons and, thus, may be formed of a highly conductive material to provide relatively low ohmic loss. The interconnect may also be selected to be stable in both low and high pO₂ environments because the interconnect may be exposed to fuel (e.g., reformed hydrocarbon fuel) on the anode side and air on the cathode side.

In some examples, an interconnect may be formed of a metal or metal alloy. For example, a metal interconnect include precious metals, such as, e.g., Pt and/or Pd, or alloys thereof, since other metals oxidize in air at high temperature. Interconnects including precious metal(s), alloys thereof, or precious metal/alloy cermet may be used to form interconnects of a SOFC, such as, e.g., an Integrated Planar SOFC system.

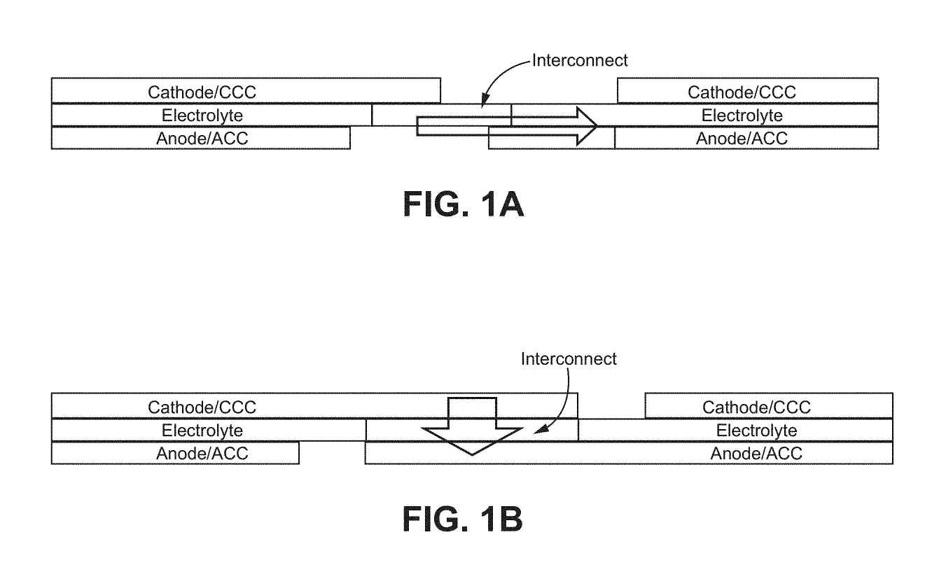

Ceramic materials may also be used to form interconnects. In some examples, high electronic conductivity (e.g., above 1 S/cm) is required if electron flowing through the thickness of a ceramic interconnect layer. However, such conductivity may not be high enough yet to have a structure of lateral current path through interconnects between ACC (or anode) and CCC (or cathode), as shown in FIG. 1A, due to high ohmic loss. Accordingly, in some examples fuel cell stack designs, the ceramic interconnect may be configured such that there is a perpendicular current path through interconnects, as shown in FIG. 1B.

In some examples, an interconnect may include a precious metal cermet. When precious metal cermet is used as an interconnect material, two different degradation mechanisms of the interconnect may be present. First, Ni in the ACC/anode may migrate through defects, such as pores, micro-cracks, of a chemical barrier layer separating the ACC/anode from the interconnect, into the metal phase in the interconnect to near the electrolyte edge location (on the CCC side) during long term operation. This Ni metal may be oxidized due to high pO₂ at the edge location, which may increase the interconnect (also referred to as I-via) resistance. Second, the interconnect may lose precious metal in the area of the interconnect which is not covered by either an extension of the electrolyte or the CCC/cathode layer due to the interaction with the flowing air environment on the air side at high temperatures (e.g., during operation), which may also increase resistance of the interconnect.

To address the second degradation mechanism, in some examples, the interconnect may be fully covered by the CCC layer to reduce precious metal interaction with the high speed air of the air environment. However, some degree overlap between the CCC layer and extended electrolyte of an adjacent cell may be unavoidable in mass production, e.g., due to misalignment and tube dimension change during processing. Such overlap may create extra parasitic loss in interconnect area, which may reduce fuel cell system efficiency, e.g., since the porous CCC layer may also function as a cathode and the interconnect may be a mixed conductor (which can be functioned as electrolyte) in some cases and, also contacting the anode materials on the other side of the interconnect. In some examples, even if the interconnect is fully covered by CCC layer, the precious metal loss may not be prevented since the CCC layer may be relatively porous and interaction between precious metal and air still exists.

In accordance with one or more examples of the disclosure, a fuel cell system may include a dense oxygen barrier layer separating the interconnect from the CCC (or cathode) layer. The dense oxygen barrier layer may be located to prevent a direct interface between the CCC (or cathode) layer and the interconnect. The dense oxygen barrier layer may be formed of a ceramic material exhibiting a low porosity and a high conductivity such that the dense oxygen barrier layer reduces at least one precious metal loss from the interconnect or oxidation of nickel metal in the interconnect. For example, the high conductivity of the ceramic material of the dense oxygen barrier layer may be selected to transport electron from interconnect to cathode or cathode conductor layer. Additionally, the low porosity of the ceramic material of the dense oxygen barrier layer may be selected to prevent or otherwise reduce oxygen from reaching the interconnect, e.g., by way of the CCC (or cathode) layer. In this manner, the dense oxygen barrier layer between CCC (or cathode) layer and interconnect may block oxygen diffusion into the interconnect and to prevent not only Ni oxidation, which diffuses from anode or anode conductor layer to the metal phase of interconnect through chemical barrier layer, but also Pd oxidation (or other precious metal of the interconnect), or evaporation that may occur at high temperature.

In some examples, the dense oxygen barrier may be configured to overlap an extended portion of the electrolyte layer to ensure full coverage of the interconnect, e.g., to prevent precious metal loss. Overlapping of dense oxygen barrier layer on extended electrolyte from adjacent cell on right side may cause some parasitic loss. However, this parasitic loss may be negligible because the dense oxygen barrier layer is an inactive electrode due to very low triple phase boundary, e.g., compared to the porous CCC layer.

As will be apparent from the description herein, some examples of the disclosure may provide one or more advantages. For example, the dense oxygen barrier layer on top of an interconnect may fully separate interaction between high-flow air and precious metal of the interconnect to improve long term durability of the interconnect by substantially eliminating or reducing precious metal loss. As another example, the dense oxygen barrier may be formed of a conductive ceramic that has high electronic conductivity (e.g., approximately 1 S/cm or greater) and also low, or negligible ionic conductivity (with regard to oxygen transport through oxygen vacancies in the crystal lattice), which may create low pO₂ in the interconnect or at interconnect/dense oxygen barrier interface to avoid Ni oxidation and keep the resistance of the interconnect relatively low. The Ni may be present in the metal phase of the interconnect, e.g., due to Ni migration from the ACC/anode through a chemical barrier layer. As another example, if the interconnect material is made from Pd or Pd alloy cermet, the dense oxygen barrier layer may prevent Pd oxidation under some operating conditions (Pd oxidation temperature is about 790 degrees Celsius in ambient air) by keeping low pO₂ in the interconnect, especially at the interface of dense oxygen barrier and interconnect, and preventing air interaction with precious metal. As another example, the parasitic loss in a fuel cell system may be reduced since the dense oxygen barrier is a less active electrode compared to a porous CCC layer and may block other pathways for oxygen transportation (e.g., through porous cathode or cathode conductor layer) to extended electrolyte surface for electrochemical reaction. As another example, employing a dense oxygen barrier layer in the manner described herein may reduce interconnect area specific resistance (ASR) by improving physical contact at dense oxygen barrier layer/interconnect interface.

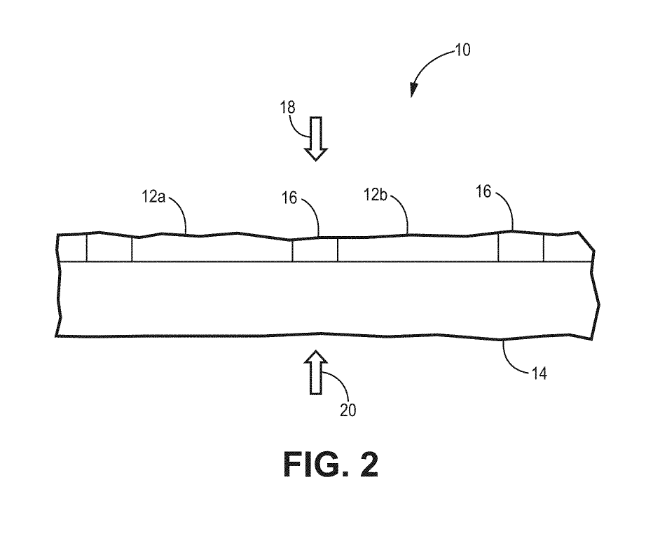

FIG. 2 is a conceptual diagram illustrating an example fuel cell system 10. As shown in FIG. 1, fuel cell system 10 includes a plurality of electrochemical cells 12 (individually labelled as first electrochemical cell 12a and second electrochemical cell 12b) formed on substrate 14. Electrochemical cells 12 are coupled together in series by interconnect 16. Although not shown in FIG. 2, fuel cell system 10 may include dense oxygen barrier layer separating interconnects 16 from the cathode conductor layer or cathode layer of the respective individual electrochemical cells. Fuel cell system 10 may be a segmented-in-series arrangement deposited on a flat porous ceramic tube, although it will be understood that the present disclosure is equally applicable to segmented-in-series arrangements on other substrates, such on a circular porous ceramic tube. In various embodiments, fuel cell system 10 may be an integrated planar fuel cell system or a tubular fuel cell system.

Each electrochemical cell 12 includes an oxidant side 18 and a fuel side 20. The oxidant is generally air, but could also be pure oxygen (O₂) or other oxidants, e.g., including dilute air for fuel cell systems having air recycle loops, and is supplied to electrochemical cells 12 from oxidant side 18. Substrate 14 may be specifically engineered porosity, e.g., the porous ceramic material is stable at fuel cell operation conditions and chemically compatible with other fuel cell materials. In other embodiments, substrate 14 may be a surface-modified material, e.g., a porous ceramic material having a coating or other surface modification, e.g., configured to prevent or reduce interaction between electrochemical cell 12 layers and substrate 14. A fuel, such as a reformed hydrocarbon fuel, e.g., synthesis gas, is supplied to electrochemical cells 12 from fuel side 20 via channels (not shown) in porous substrate 14. Although air and synthesis gas reformed from a hydrocarbon fuel may be employed in some examples, it will be understood that electrochemical cells using other oxidants and fuels may be employed without departing from the scope of the present disclosure, e.g., pure hydrogen and pure oxygen. In addition, although fuel is supplied to electrochemical cells 12 via substrate 14, it will be understood that in other embodiments, the oxidant may be supplied to the electrochemical cells via a porous substrate.

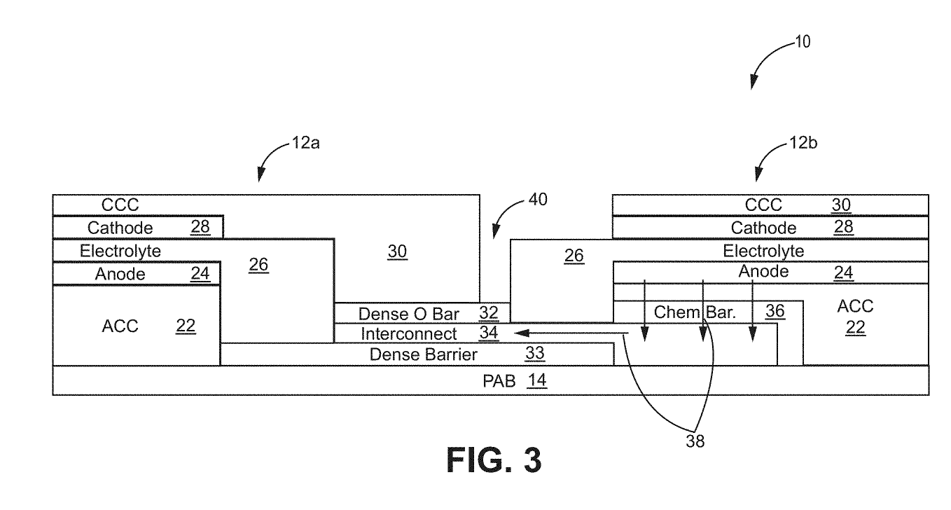

FIG. 3 is a conceptual diagram illustrating an example cross-section of fuel cell system 10 in accordance with an embodiment of the present disclosure. Both first and second electrochemical cells 12a and 12b of fuel cell system 10 layers include an anode conductor layer (ACC) 22, an anode layer 24, an electrolyte layer 26, a cathode layer 28, a cathode conductor layer (CCC) 30, dense oxygen barrier layer 32, dense barrier 33 and interconnect layer 34. Respective layers may be a single layer or may be formed of any number of sub-layers. It will be understood that FIG. 3 is not necessarily to scale. For example, vertical dimensions are exaggerated for purposes of clarity of illustration. The respective layers of fuel cell system 10 may be formed by screen printing of the layers onto substrate (or porous anode barrier layer) 14. This may include a process whereby a woven mesh has openings through which the fuel cell layers are deposited onto substrate (referred to as PAB 14 in FIG. 3). The openings of the screen determine the length and width of the printed layers. Screen mesh, wire diameter, and ink solids loading may determine the thickness of the printed layers after firing.

In each electrochemical cell 12, anode conductor layer 22 conducts free electrons away from anode 24 and conducts the electrons to cathode conductor layer 30 via interconnect 16. Cathode conductor layer 30 conducts the electrons to cathode 28. Interconnects 16 for solid oxide fuel cells (SOFC) may be: electrically conductive in order to transport electrons from one electrochemical cell to another; mechanically and chemically stable under both oxidizing and reducing environments during fuel cell operation; and nonporous, in order to prevent diffusion of the fuel and/or oxidant through the interconnect. In the configuration shown in FIG. 3, in-plane conduction occurs within interconnect layer 16, similar to the configuration shown in FIG. 1b.

Anode conductor layer 22 may be an electrode conductive layer formed of a nickel cermet, such as Ni—YSZ (e.g., where yttria doping in zirconia is 3-8 mol %,), Ni—ScSZ (e.g., where scandia doping is 4-10 mol %, preferably including a second doping for example 1 mol % ceria for phase stability for 10 mol % scandia-ZrO₂) and/or Ni-doped ceria (such as Gd or Sm doping), doped lanthanum chromite (such as Ca doping on A site and Zn doping on B site), doped strontium titanate (such as La doping on A site and Mn doping on B site), La₁₋ₓSrₓMn_{y}Cr_{1-y}O₃ and/or Mn-based R-P phases of the general formula a (La₁₋ₓSrₓ)ₙ₊₁MnₙO₃ₙ₊₁. Alternatively, it is considered that other materials for anode conductor layer 22 may be employed such as cermets based in part or whole on precious metal. Precious metals in the cermet may include, for example, Pt, Pd, Au, Ag, and/or alloys thereof. The ceramic phase may include, for example, an inactive non-electrically conductive phase, including, for example, YSZ, ScSZ and/or one or more other inactive phases, e.g., having desired CTE in order to control the CTE of the layer to match the CTE of the substrate and electrolyte. In some embodiments, the ceramic phase may include Al₂O₃ and/or a spinel such as NiAl₂O₄, MgAl₂O₄, MgCr₂O₄, and NiCr₂O₄. In other embodiments, the ceramic phase may be electrically conductive, e.g., doped lanthanum chromite, doped strontium titanate and/or one or more forms of LaSrMnCrO and/or R-P phases of the general formula (La₁₋ₓSrₓ)ₙ₊₁MnₙO₃ₙ₊₁.

Electrolyte layer 26 may be made from a ceramic material. In one form, a proton and/or oxygen ion conducting ceramic, may be employed. In one form, electrolyte layer 26 is formed of YSZ, such as 3YSZ and/or 8YSZ. In other embodiments, electrolyte layer 26 may be formed of ScSZ, such as 4ScSZ, 6ScSz and/or 10Sc1CeSZ in addition to or in place of YSZ. In other embodiments, other materials may be employed. For example, it is alternatively considered that electrolyte layer 26 may be made of doped ceria and/or doped lanthanum gallate. In any event, electrolyte layer 26 is substantially impervious to diffusion therethrough of the fluids used by fuel cell 10, e.g., synthesis gas or pure hydrogen as fuel, as well as, e.g., air or O2 as an oxidant, but allows diffusion of oxygen ions or protons. Dense barrier 33 forms a continuous dense layer with electrolyte 26 to block fuel leakage to the air side or air leakage to the fuels side. In some example, dense barrier 33 is formed from 3YSZ.

Cathode layer 28 may be ceramic composite formed from at least one of LSM (La₁₋ₓSrₓMnO₃, where x=0.1 to 0.3), La₁₋ₓSrₓFeO₃ (such as where x=0.3), La₁₋ₓSrₓCo_{y}Fe_{1-y}O₃ (such as La_{0.6}Sr_{0.4}Co_{0.2}Fe_{0.8}O₃) and/or Pr₁₋ₓSrₓMnO₃ (such as Pr_{0.8}Sr_{0.2}MnO₃), although other materials may be employed without departing from the scope of the present invention. For example, it is alternatively considered that Ruddlesden-Popper nickelates and La₁₋ₓCaₓMnO₃ (such as La_{0.8}Ca_{0.2}MnO₃) materials may be employed.

Cathode conductor layer 30 may be an electrode conductive layer formed of a conductive ceramic, for example, at least one of LaNiₓFe₁₋ₓO₃ (such as, e.g., LaNi_{0.6}Fe_{0.4}O₃), La₁₋ₓSrₓMnO₃ (such as La_{0.75}Sr_{0.25}MnO₃), and/or Pr₁₋ₓSrₓCoO₃, such as Pr_{0.8}Sr_{0.2}CoO₃. In other embodiments, cathode conductor layer 30 may be formed of other materials, e.g., a precious metal cermet, although other materials may be employed without departing from the scope of the present invention. The precious metals in the precious metal cermet may include, for example, Pt, Pd, Au, Ag and/or alloys thereof. The ceramic phase may include, for example, YSZ, ScSZ and Al₂O₃, or other non-conductive ceramic materials as desired to control thermal expansion.

In some examples, anode conductor layer 22 has a thickness of approximately 5-15 microns, although other values may be employed without departing from the scope of the present disclosure. For example, it is considered that in other embodiments, the anode conductor layer may have a thickness in the range of approximately 5-50 microns. Similarly, anode layer 24 may have a thickness of approximately 5-20 microns, although other values may be employed without departing from the scope of the present invention. For example, it is considered that in other embodiments, the anode layer may have a thickness in the range of approximately 5-40 microns. Electrolyte layer 26 may have a thickness of approximately 5-15 microns with individual sub-layer thicknesses of approximately 5 microns minimum, although other thickness values may be employed without departing from the scope of the present invention. For example, it is considered that in other embodiments, the electrolyte layer may have a thickness in the range of approximately 5-40 microns. Cathode layer 28 may have a thickness of approximately 10-20 microns, although other values may be employed without departing from the scope of the present invention. For example, it is considered that in other embodiments, the cathode layer may have a thickness in the range of approximately 10-50 microns. Cathode conductor layer 30 may have a thickness of approximately 5-100 microns, e.g., approximately 60-80 microns, although other values may be employed without departing from the scope of the present invention.

Interconnect 16 may be formed of a precious metal including Ag, Pd, Au and/or Pt and/or alloys thereof, although other materials may be employed without departing from the scope of the present disclosure. For example, in other embodiments, it is alternatively contemplated that other materials may be employed, including precious metal alloys, such as Ag—Pd, Ag—Au, Ag—Pt, Au—Pd, Au—Pt, Pt—Pd, Ag—Au—Pd, Ag—Au—Pt, Ag—Au—Pd—Pt and/or binary, ternary, quaternary alloys in the Pt—Pd—Au—Ag family, inclusive of alloys having minor non-precious metal additions, cermets composed of a precious metal, precious metal alloy, and an inert ceramic phase, such as alumina, or ceramic phase with minimum ionic conductivity which will not create significant parasitics, such as YSZ (yttria stabilized zirconia, also known as yttria doped zirconia, yttria doping is 3-8 mol %, preferably 3-5 mol %), ScSZ (scandia stabilized zirconia, scandia doping is 4-10 mol %, preferably 4-6 mol %), doped ceria, and/or conductive ceramics, such as conductive perovskites with A or B-site substitutions or doping to achieve adequate phase stability and/or sufficient conductivity as an interconnect, e.g., including at least one of doped strontium titanate (such as LaₓSr₁₋ₓTiO_{3-δ}, x=0.1 to 0.3), LSCM (La₁₋ₓSrxCr_{1-y}Mn_{y}O₃, x=0.1 to 0.3 and y=0.25 to 0.75), doped yttrium chromites (such as Y₁₋ₓCaₓCrO_{3-δ}, x=0.1-0.3) and/or other doped lanthanum chromites (such as La₁₋ₓCaₓCrO_{3-δ}, where x=0.15-0.3), and conductive ceramics, such as doped strontium titanate, doped yttrium chromites, LSCM (La₁₋ₓSrₓCr_{1-y}Mn_{y}O₃), and other doped lanthanum chromites. In one example, interconnect 16 may be formed of y(PdₓPt₁₋ₓ)-(1-y)YSZ, where x is from 0 to 1 in weight ratio, preferably x is in the range of 0 to 0.5 for lower hydrogen flux, and y is from 0.35 to 0.80 in volume ratio, preferably y is in the range of 0.4 to 0.6.

As shown in FIG. 3, fuel cell system 10 may include chemical barrier layer 36 between interconnect 16 and anode conductor layer 22 (or anode 24) to reduce or prevent diffusion between interconnect 34 and anode conductor layer 22 (or anode 24), e.g., along path 38, which may adversely affect the performance of certain fuel cell systems. For example, without a chemical barrier, material migration (diffusion) may take place at the interface between interconnect 34 formed of a precious metal cermet, and anode conductor film 22 and/or anode 24 formed of a Ni-based cermet. The material migration may take place in both directions, e.g., Ni migrating from the anode conductor layer 22 and/or anode 24 into the interconnect, and precious metal migrating from interconnect 34 into the conductive anode conductor layer 22 and/or anode 24. The material migration may result in increased porosity at or near the interface between interconnect 34 and anode conductor layer 22 and/or anode 24, and may result in the enrichment of one or more non or low-electronic conducting phases at the interface and yielding a higher ASR, hence resulting in reduced fuel cell performance.

However, in some examples, at least some Ni may migrate through chemical barrier layer 36 into interconnect 34 from anode conductor layer 22 and/or anode 24 along path 38, e.g., through defects, such as pores, micro-cracks. Alternatively, chemical barrier layer 36 may not be present, in which case, the Ni may directly migrate into interconnect 34. If the Ni metal in interconnect 34 is oxidized, the oxidation may increase the electronic resistance of interconnect 34.

In accordance with some examples of the disclosure, fuel cell system 10 also includes dense oxygen barrier layer 32 between cathode conductor layer 30 and interconnect 34. Dense oxygen barrier layer 32 may prevent or otherwise reduce the oxidation of Ni metal in interconnect 34, e.g., by preventing or otherwise reducing the diffusion of oxygen into interconnect 34 from cathode conductor layer 30 and/or cathode layer 28. Without dense oxygen barrier layer, interconnect 34 may be in direct contact with cathode conductor layer 30 (or cathode layer 28 in configurations in which electrochemical cell 12a does not include cathode conductor layer 30) such that oxygen from cathode conductor layer 30 may be transported into interconnect 34, allowing for the oxidation of Ni present in interconnect 34 and/or oxidation of Pd or other precious metal in interconnect 34 that may occur at high temperature. Similarly, dense oxygen barrier layer 32 also covers the portion of interconnect 34 that would otherwise be directly exposed to the air environment by way of gap 40 between cathode conductor 30 and electrolyte 26 to prevent or otherwise reduce the oxidation of Ni metal and/or precious metal in interconnect 34, e.g., by preventing or otherwise reducing the diffusion of oxygen into interconnect 34 from the air environment. Gap 40 between cathode conductor 30 and electrolyte 26 may be provided, e.g., to avoid parasitic cells and reduce the risk of short circuit.

Additionally, dense oxygen barrier layer 32 may also prevent or otherwise reduce the diffusion of Ni and/or Pd or other precious metal in interconnect 34 into cathode conductor layer 30 (or cathode 28), e.g., as compared to a configuration in which interconnect 34 and cathode conductor layer 30 are in direct contact with each other.

Dense oxygen barrier layer 32 may be formed of a suitable conductive ceramic material. Dense oxygen barrier 32 may be formed of ceramic material that exhibits an electronic conductivity that prevents or otherwise reduces the diffusion of precious metal and/or Ni metal diffusion from interconnect 34 to cathode conductor 30, and a low porosity that prevents or otherwise reduces the diffusion of oxygen into interconnect 34 from cathode conductor 30 and/or from air environment within gap 40. In some examples, dense oxygen barrier layer 32 exhibits a porosity of approximately 10 percent or less, such as, e.g., approximately 5 percent or less to block oxygen. In some examples, dense oxygen barrier layer 32 exhibits an electronic conductivity of approximately 1 S/cm or greater, such as, e.g., approximately 2 S/cm or greater. In some examples, the high conductivity and low porosity of dense oxygen barrier 32 may provide for improved contact with interconnect 34. Such improved contact may allow and/or improve transport of electrons from interconnect to the one of the cathode 28 or the cathode conductor layer 30 with lower area specific resistance (ASR) contribution from the interconnect during fuel cell operation. In some examples, the ASR of primary interconnect (PIC) with dense oxygen barrier may be improved by approximately 0.01 ohm-cm² to approximately 0.04 ohm-cm².

In the some examples, the selected ceramic material may have a coefficient of thermal expansion (CTE) and chemical composition that is compatible with cathode conductor 30 (or cathode 28) and/or electrolyte materials, such as LSM, LNF, (Mn,Co)₃O₄, and the like.

Example ceramic materials suitable for forming dense oxygen barrier layer include:

1. A conductive spinel oxide such as (Mn,Co)₃O₄, (Cu,Fe)₃O₄, and the like.

2. (Mn,Co,Aₓ)₃O₄ spinel, where A is transition metal, such as Cu, Co, Cr, AI, and the like, and where 0<x<0.1.

3. A conductive spinel that forms a composite with ionic phase for compatibility and other consideration, such as, not limited to, YSZ, ScSZ, and the like. In some examples, the ionic phase may less than approximately 30 vol % to avoid a parasitic cell.

4. An ABO₃ perovskite, such as LSM, LNF, PSM, LSC, LSCF, LSCM, LSMT, and the like.

5. A transition metal doped perovskite on the B site, such as Cu, Co, Cr, Al, and the like. In some examples, the transition metal is ≦0.1 on the B site.

6. An ABO₃ perovskite that forms a composite with ionic phase for compatibility and other consideration, such as, not limited to, YSZ, ScSZ, and the like. In some examples, the ionic phase may be less than approximately 30 vol % to avoid a parasitic cell.

7. A spinel oxide-ABO₃ perovskite composite such as (Mn,Co,Aₓ)₃O₄—LNF, ((Mn,Co,Aₓ)₃O₄—LSM, where A is transition metal and 0≦x<0.1.

8. LSM, where a sintering aid, such as BaCuO₂—CuO, NiO, may be used to increase the densification of the layer.

9. LNF, where a sintering aid, such as B₂O₃, may be used to increase the densification of the layer.

In some examples, dense oxygen barrier layer 32 may have a thickness in the range of about 1 to about 100 microns, preferably, in some examples, in the range of about 5 to about 20 microns or about 10 microns.

Any suitable technique may be used to form dense oxygen barrier layer. In some examples, dense oxygen barrier 32 may be made through co-firing with electrolyte layer if it has higher sintering temperatures, such as LSM, doped LSM, or doped (Mn,Co)₃O₄ spinel. Dense oxygen barrier 32 may also be made through co-firing with cathode layer 28 and/or cathode conductor layer 30, e.g., if it has lower sintering temperature, such as (Mn,Co)₃O₄ spinel. Dense oxygen barrier 32 may also be made through separate firing at preferred temperatures.

Dense oxygen barrier 32 may be employed in SOFCs where precious metal, or precious metal alloy, or precious metal/alloy cermet is used as interconnect. Dense oxygen barrier 32 may be employed to all interconnect designs in IP-SOFCs where electron flows in-plane through interconnect, e.g., where interconnect is a long strip embedded partially between extended electrolyte and dense barrier layer, and/or where interconnect is a via design partially embedded between extended electrolyte and dense barrier layer.

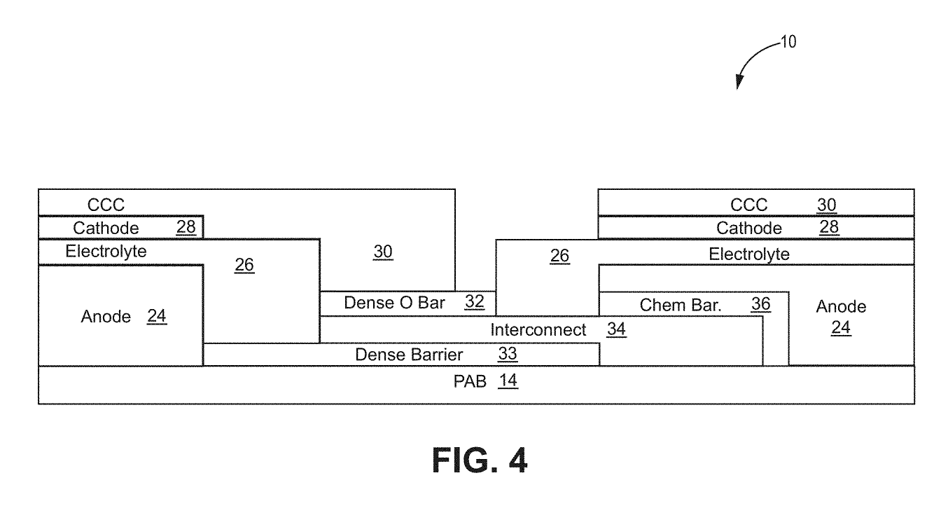

FIG. 4 is a conceptual diagram illustrating another example cross-section of fuel cell system 10 in accordance with an embodiment of the present disclosure. Fuel cell system 10 in FIG. 4 may be the same or similar to that shown in FIG. 3. However, as shown in FIG. 4, system 10 does not include anode conductor layer 22, which is replaced by anode layer 24. In such cases, anode layer 24 may have enough conductance to transport electrons horizontally, in which case anode layer 24 may function as both active anode and ACC/anode conductor layer 22. As such, a separate ACC/anode layer is not needed with anode layer 24, as shown FIG. 4.

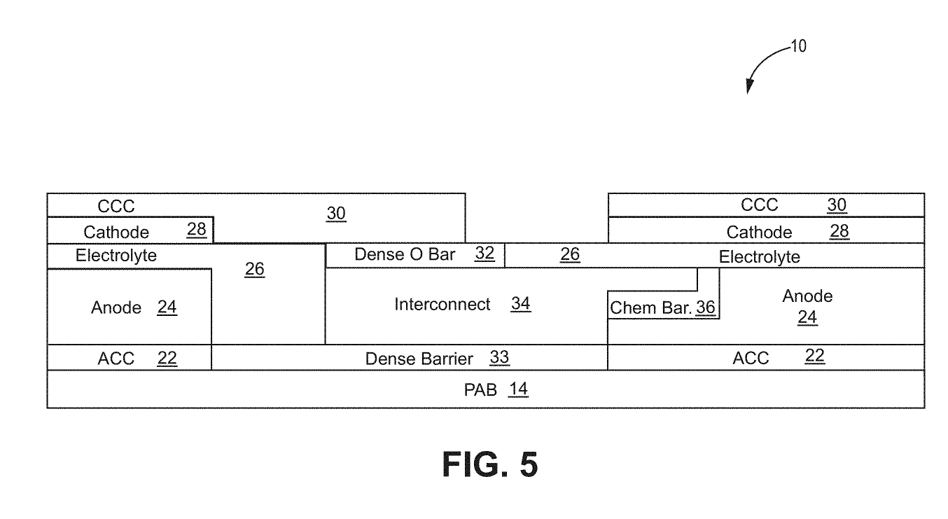

FIG. 5 is a conceptual diagram illustrating another example cross-section of fuel cell system 10 in accordance with an embodiment of the present disclosure. Fuel cell system 10 in FIG. 5 may be the same or similar to that shown in FIG. 3. However, as shown in FIG. 5, interconnect 34 extends into the active cell area between electrolyte 26 and anode layer 24/anode conductor layer 26. Such a configuration may be achieved with different printing sequence (ACC/anode conductor layer 22, anode 24, chemical barrier 36, and interconnect 34) compared to, e.g., the examples of FIGS. 3 and 4.

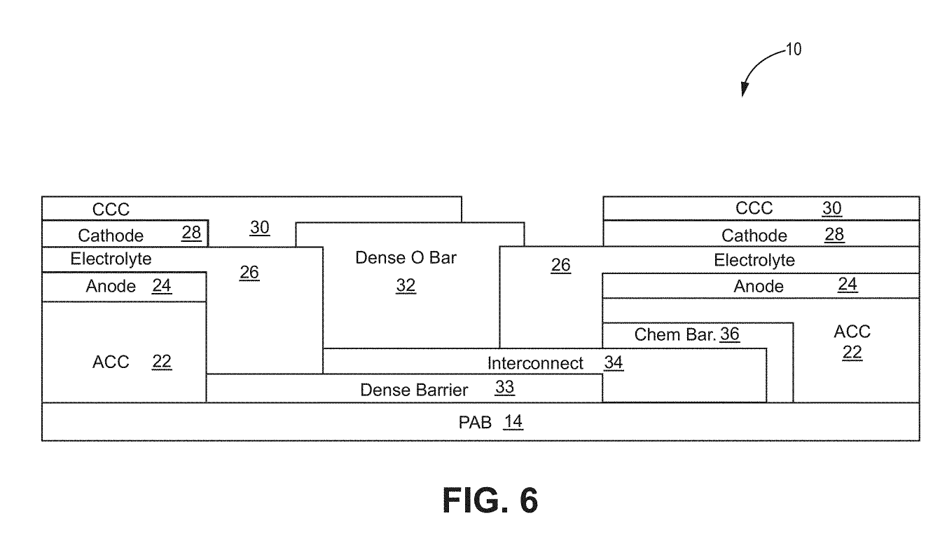

FIG. 6 is a conceptual diagram illustrating another example cross-section of fuel cell system 10 in accordance with an embodiment of the present disclosure. Fuel cell system 10 in FIG. 6 may be the same or similar to that shown in FIG. 3. However, as shown in FIG. 6, dense oxygen barrier layer 32 overlaps with electrolyte 26 and may be printed after electrolyte 26 and before cathode conductor layer 30. The overlap on the right side where there is no cathode conductor layer 30 on top of dense oxygen barrier layer 32 may create parasitic cell. However, the parasitic loss may be negligible due to inactive cathode of the dense oxygen barrier layer 32. In such a configuration, there may be two considerations: 1) to ensure the gap between electrolyte 26 is fully filled by dense oxygen barrier layer 32 to block oxygen, e.g., in case misalignment or shift during the deposition of dense oxygen barrier layer 32; and 2) the extended portion of dense oxygen barrier layer 32 on the left embedded between CCC 30 and electrolyte layer 26 shown in FIG. 6 may help to reduce parasitics. In some examples, system 10 may be configured as shown in FIG. 6 but with cathode conductor layer 30 directly adjacent electrolyte layers 26 on either side and with dense oxygen barrier layer 32 on interconnect 34 below cathode conductor layer 30.

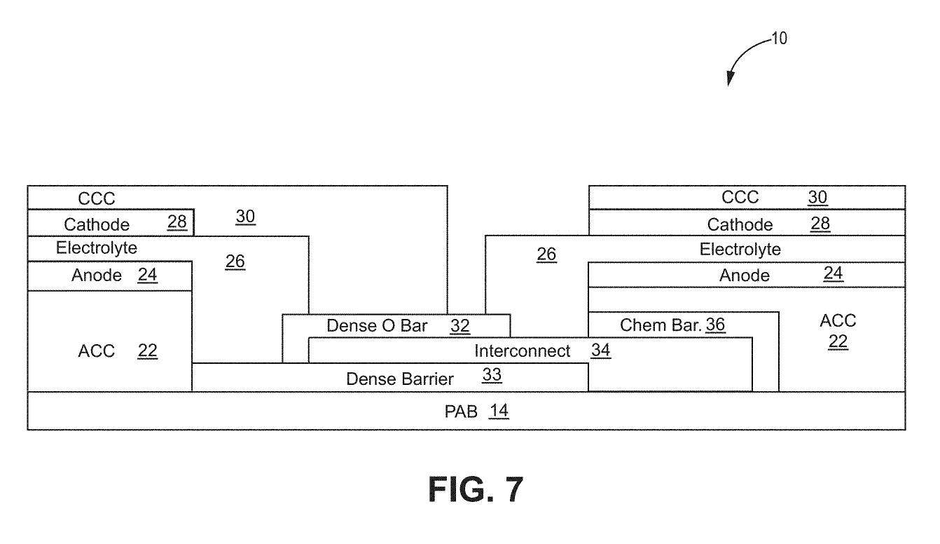

FIG. 7 is a conceptual diagram illustrating another example cross-section of fuel cell system 10 in accordance with an embodiment of the present disclosure. Fuel cell system 10 in FIG. 7 may be the same or similar to that shown in FIG. 3. However, as shown in FIG. 7, dense oxygen barrier layer 32 overlaps with electrolyte 26 and may be printed after interconnect 34 and before electrolyte layer 26. Since dense oxygen barrier layer 32 is under electrolyte 26, the configuration does not create a parasitic cell. In some examples, system 10 may be configured as shown in FIG. 7 but with dense oxygen barrier layer 32 not covering the vertical edge of interconnect 34 between interconnect 34 and electrolyte 26.

### Examples

Various experiments were carried out to evaluate one or more aspects of example dense oxygen barrier layer compositions in accordance with the disclosure. However, examples of the disclosure are not limited to the experimental compositions.

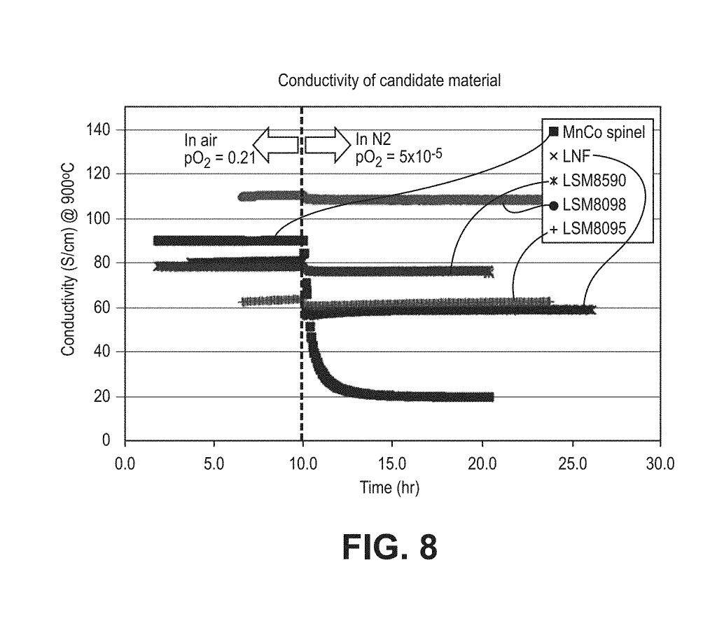

Example compositions for dense oxygen barrier were selected and the conductivity of the compositions was measured in both air and nitrogen (lower pO₂). The sample compositions were MnCo spinel, LNF, LSM8590, LSM8098, and LSM 8095. The pO₂ was approximately 0.21 in the air environment and approximately 5×10⁻⁵ in the nitrogen environment. The reason for testing in the two different environment, was that even though a dense interconnect along with a dense oxygen barrier layer and an extended electrolyte, e.g., as in FIG. 3, may be gas-tight (e.g., the material has low enough porosity and gases cannot pass through or passes through at a rate below a threshold, such as, e.g., less than or equal to about 6 standard cubic centimeters per minute (sccm)), a small amount of H₂ may transport through the alloy (e.g., when Pd is used, which has a different mechanism) phase in the interconnect material and create a lower pO₂ at the interface between the dense oxygen barrier layer and interconnect. Therefore, it may be desirable for the dense oxygen barrier to be stable at some level of low pO₂, such as the tested low pO₂ used for testing. Modeling showed that, in some examples, a dense oxygen barrier layer with a conductivity of approximately 2 S/cm or greater may provide a lower ASR for the interconnect since current flows through the thickness of dense oxygen barrier without in-plane conduction. FIG. 8 is a plot illustrating the conductivity of each of the sample composition in both air and nitrogen. As shown, all selected sample composition exhibited a conductivity of approximately 2 S/cm or greater in both the air and nitrogen environments.

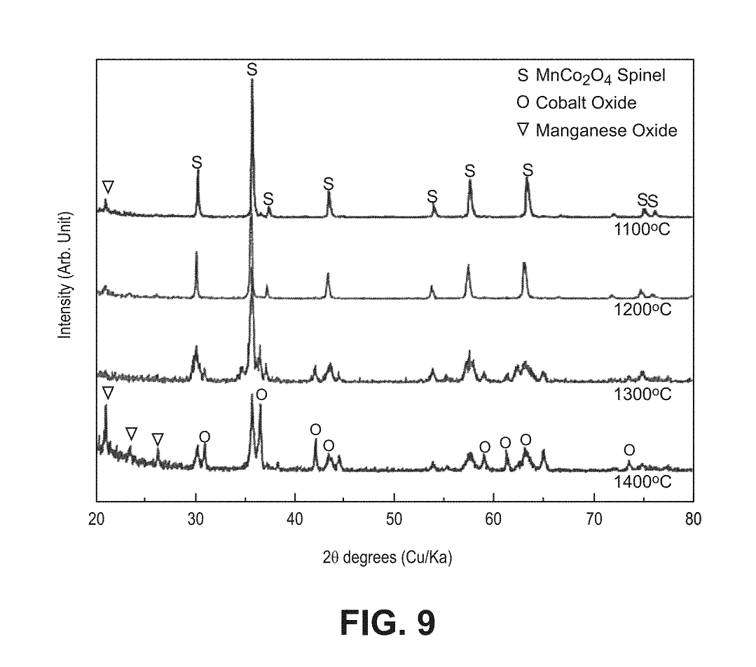

FIG. 9 is a plot illustrating XRD patterns for MnCo₂O₄ spinel samples after being sintered at 1100, 1200, 1300, and 1400 degrees Celsius (from reference: Eun Jeong Yi, Mi Young Yoon, Ji-Woong Moon, and Hae Jin Hwang, Fabrication of a MnCo₂O₄/gadolinia-doped Ceria (GDC) Dual-phase Composite Membrane for Oxygen Separation, J of the Korean Ceramic Society, 47[2]199-204, 2010). MnCo₂O₄ shows single phase when firing temperature is below 1300 degrees Celsius, which means MnCo₂O₄ may be able to be co-fired with a cathode conductor layer when using MnCo₂O₄ to form a dense oxygen barrier layer in the manner described herein. A pentacell of IP-SOFCs design (5 cells connected in series by a dense oxygen barrier layer and interconnect) was prepared, with the dense oxygen barrier layer be formed of LSM, which was fired separately. Both pentacell samples were tested at 900-925 degrees Celsius under reformate fuel and showed promising results.

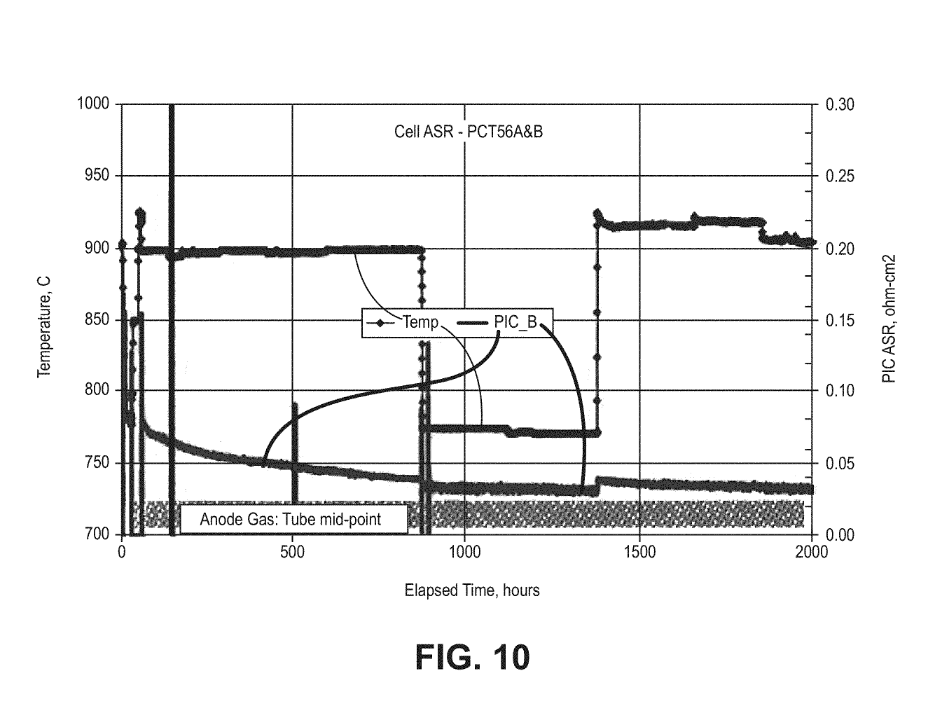

FIG. 10 is a plot illustrating the durability of the pentacell test article with a dense oxygen barrier layer. As shown, the interconnect had low ASR (e.g., as low as 0.03 ohm-cm̂2) and stable performance (e.g., substantially no degradation) up to 2000 hours (hrs).

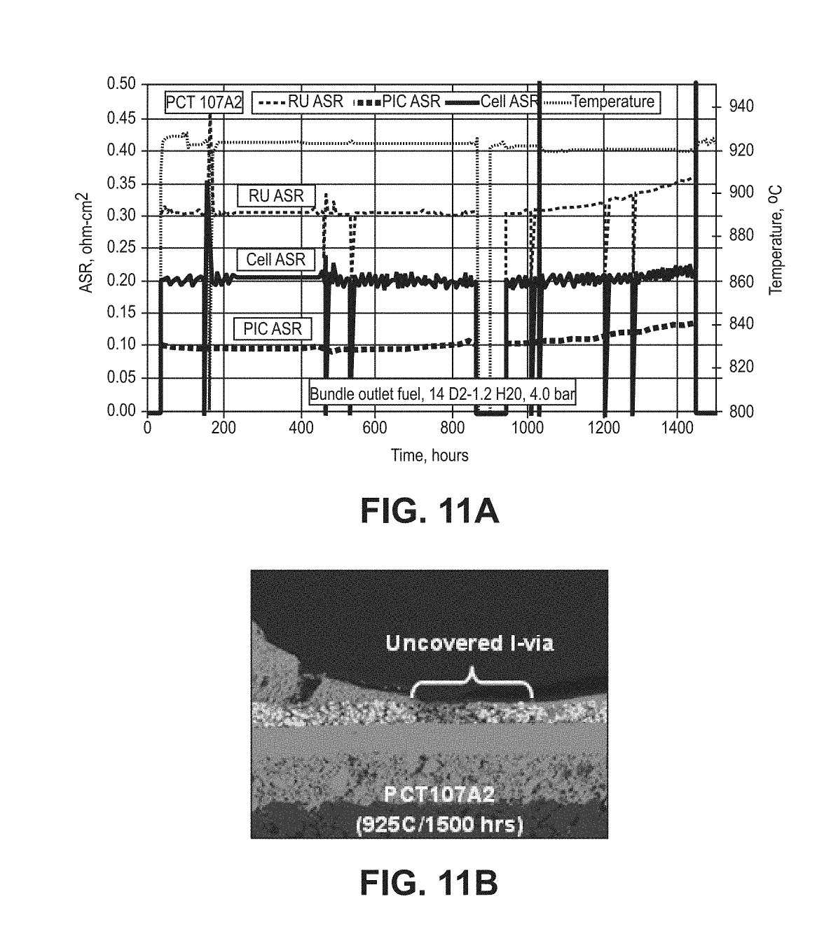

In another example, significant precious metal loss in interconnect was observed where the interconnect not covered by a CCC layer, which resulted in a primary interconnect ASR increase. FIG. 11A is a plot illustrating the ASR durability from the testing and FIG. 11B is SEM image showing the precious metal loss from the uncovered interconnect. The ASR durability and post-test analysis of the subscale cell (PCT107A2) illustrate interconnect degradation (FIG. 11A) and due to precious metal loss (FIG. 11B).

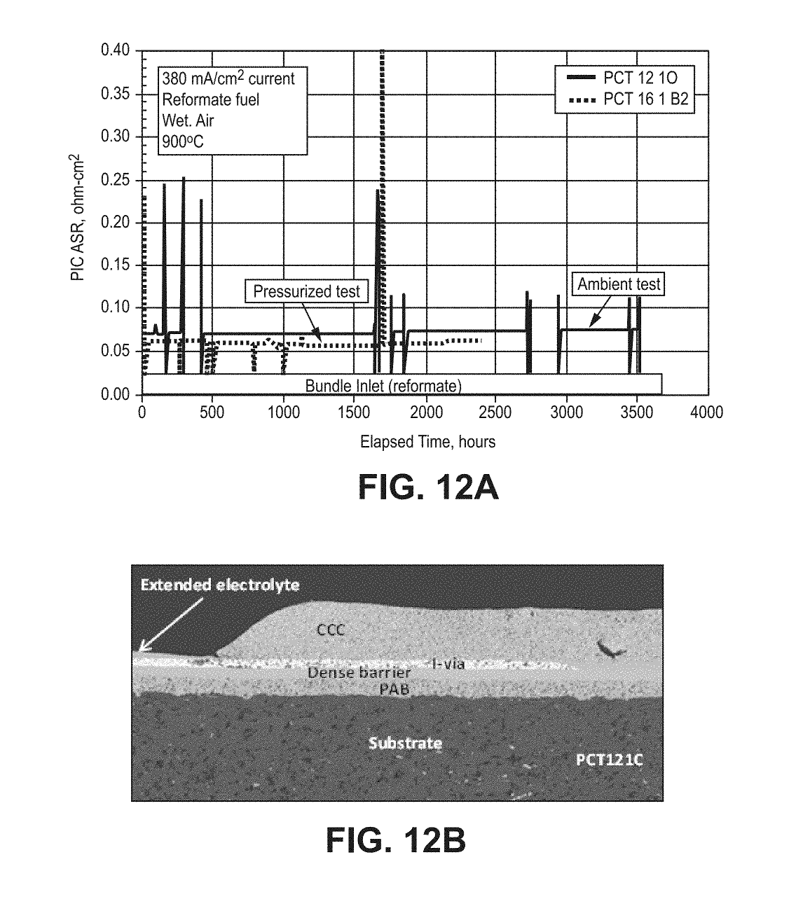

However, in another example, when the interconnect was fully covered by a CCC layer, much less precious metal loss from interconnect was observed and the PIC ASR was found to be stable over 3,500 hrs of operation. FIG. 12A is a plot illustrating the ASR durability from the testing and FIG. 12B is SEM image showing the interconnect (labelled I-via) after the 3,500 hrs of operation. The ASR durability and post-test analysis of the subscale cell illustrated stable performance and much less precious metal loss, e.g., due to the CCC layer abutting at electrolyte edge and interconnect fully covered by the CCC layer.

Although not wishing to be bound by theory, it was thought that since CCC is a porous layer, theoretically precious metal loss mechanism may still exist through the interaction with gas steam in cathode side based on the results. It is believed that if a dense oxygen barrier was applied between CCC and interconnect layer, the precious metal loss mechanism may be eliminated or otherwise reduced.

Various embodiments of the invention have been described. These and other embodiments are within the scope of the following claims.

1. A fuel cell comprising:
a first electrochemical cell;
a second electrochemical cell;
an interconnect configured to conduct a flow of electrons from the first electrochemical cell to the second electrochemical cell; and
a dense oxygen barrier layer separating the interconnect from one of a cathode or a cathode conductor layer adjacent the cathode, wherein the dense barrier layer is formed of a ceramic material exhibiting a low porosity and a high conductivity such that the dense oxygen barrier layer reduces at least one precious metal loss from the interconnect or oxidation of nickel metal in the interconnect.

2. The fuel cell of claim 1, wherein the low porosity of the dense oxygen barrier layer prevents diffusion of oxygen into the interconnect from the one of a cathode or a cathode conductor layer.

3. The fuel cell of claim 1, wherein the dense oxygen barrier layer separates the interconnect from an air environment, wherein the low porosity of the dense oxygen barrier layer prevents diffusion of oxygen into the interconnect from the air environment.

4. The fuel cell of claim 3, wherein the high conductivity and low porosity increases contact of the dense oxygen barrier layer with the interconnect to allow transport of electrons from the interconnect to the one of the cathode or the cathode conductor layer with lower area specific resistance (ASR) contribution from the interconnect during fuel cell operation.

5. The fuel cell of claim 1, wherein the low porosity of the dense oxygen barrier layer prevents diffusion of the precious metal from the interconnect into the one of a cathode or a cathode conductor layer.

6. The fuel cell of claim 1, wherein the low porosity of the dense oxygen barrier layer prevents evaporation of precious metal in the interconnect during fuel cell operation.

7. The fuel cell of claim 1, wherein the low porosity of the dense oxygen barrier layer prevents oxidation of nickel in the interconnect to form nickel oxide, wherein the nickel in the interconnect migrated from an anode or anode conductor of the first cell through a chemical barrier layer to a metal phase of the interconnect.

8. The fuel cell of claim 1, wherein the dense oxygen barrier layer exhibits a porosity of approximately 10 vol % or less.

9. The fuel cell of claim 1, wherein the dense oxygen barrier layer exhibits an electronic conductivity of approximately 1 S/cm or greater.

10. The fuel cell of claim 1, wherein the precious metal comprises Pd.

11. The fuel cell of claim 1, wherein the dense oxygen barrier layer overlaps with an electrolyte and is embedded between the electrolyte and an extended portion of the cathode conductor layer to reduce parasitic loss.

12. A method for manufacturing a fuel cell, the method comprising forming a first electrochemical cell, a second electrochemical cell, an interconnect configured to conduct a flow of electrons from the first electrochemical cell to the second electrochemical cell, and a dense oxygen barrier layer separating the interconnect from one of a cathode or a cathode conductor layer adjacent the cathode, wherein the dense barrier layer is formed of a ceramic material exhibiting a low porosity and a high conductivity such that the dense oxygen barrier layer reduces at least one precious metal loss from the interconnect or oxidation of nickel metal in the interconnect.

13. The method of claim 12, wherein the low porosity of the dense oxygen barrier layer prevents diffusion of oxygen into the interconnect from the one of a cathode or a cathode conductor layer.

14. The method of claim 12, wherein the dense oxygen barrier layer separates the interconnect from an air environment, wherein the low porosity of the dense oxygen barrier layer prevents diffusion of oxygen into the interconnect from the air environment.

15. The method of claim 14, wherein the high conductivity and low porosity increases contact of the dense oxygen barrier layer with the interconnect to allow transport of electrons from the interconnect to the one of the cathode or the cathode conductor layer with lower area specific resistance (ASR) contribution from the interconnect during fuel cell operation.

16. The method of claim 12, wherein the low porosity of the dense oxygen barrier layer prevents diffusion of the precious metal from the interconnect into the one of a cathode or a cathode conductor layer.

17. The method of claim 12, wherein the low porosity of the dense oxygen barrier layer prevents evaporation of precious metal in the interconnect during fuel cell operation.

18. The method of claim 12, wherein the low porosity of the dense oxygen barrier layer prevents oxidation of nickel in the interconnect to form nickel oxide, wherein the nickel in the interconnect migrated from an anode or anode conductor of the first cell through a chemical barrier layer to a metal phase of the interconnect.

19. The method of claim 12, wherein the dense oxygen barrier layer exhibits a porosity of approximately 10 vol % or less and a conductivity of approximately 1 S/cm or greater.

20. A method comprising controlling operation of a fuel cell system to generate electricity, wherein the fuel cell system comprises:
a first electrochemical cell;
a second electrochemical cell;
an interconnect configured to conduct a flow of electrons from the first electrochemical cell to the second electrochemical cell; and
a dense oxygen barrier layer separating the interconnect from one of a cathode or a cathode conductor layer adjacent the cathode, wherein the dense barrier layer is formed of a ceramic material exhibiting a low porosity and a high conductivity such that the dense oxygen barrier layer reduces at least one precious metal loss from the interconnect or oxidation of nickel metal in the interconnect.
